(19) United States
(12) Patent Application Publication
(10) Pub. No.: US 2011/0310617 A1
(43) Pub. Date: Dec. 22, 2011

(54) LIGHT GUIDE APPARATUS

(75) Inventors: Hugo Johan Cornelissen, Eindhoven (NL); Gongming Wei, Shangai (CN)

(73) Assignee: KONINKLIJKE PHILIPS ELECTRONICS N.V., EINDHOVEN (NL)

(21) Appl. No.: 13/255,731

(22) PCT Filed: Mar. 10, 2010
(86) PCT No.: PCT/IB10/51018

§ 371 Date: Sep. 9, 2011

(30) Foreign Application Priority Data
Mar. 11, 2009 (CN) 200910126285.2

(51) Int. Cl. G02B 6/00; F21V 7/00

(52) U.S. Cl. 362/296.09; 362/257; 362/296.01

(57) ABSTRACT

The invention discloses a light guide apparatus which comprises a light guide (1). The light guide (1) comprises a plurality of diffraction gratings (2) on a first surface of the light guide (1), wherein each diffraction grating (2) has a pre-set pitch and is configured to diffract a portion of light emitted from a corresponding light source to one side of the light guide (1). As the plurality of diffraction gratings (2) is placed on the first surface of the light guide (1) facing the light sources, the light guide apparatus is more robust to damage and fingerprints.

### TECHNICAL FIELD

The present invention relates to an illumination field, especially a light measurement field.

### BACKGROUND OF THE INVENTION

A previous Philips patent application publication, international publication number: WO 2007/015195 A1, entitled “ILLUMINATION SYSTEM, LIGHT-SENSING PLATE AND DISPLAY DEVICE”, filed on Jul. 26, 2006, proposes an illumination system and a light-sensing plate for use in the illumination system. As shown in FIG. 1, the illumination system comprises at least one light source, a light-transmissive light-sensing plate 5′, surface-modification structures 21′,22′ and at least one light sensor 11′, 12′. The surface-modification structures 21′,22′ are provided at least at one predetermined location on a surface of the light-sensing plate 5′ and divert a portion of the light traveling through the light-sensing plate 5′ and the diverted light is guided towards an edge surface 15′,16′ of the light-sensing plate 5′. The at least one light sensor 11′,12′ is coupled to the edge surface 15′,16′ of the light-sensing plate 5′ for sensing the light diverted at the surface-modification structures 21′,22′. The at least one light sensor 11′,12′ is coupled to a control means for controlling the luminous flux of the at least one light source.

### SUMMARY OF THE INVENTION

The present invention is an improvement over the previous one.

It would be advantageous to achieve a light guide with a plurality of diffraction gratings thereon, which is more robust to damage and fingerprints. It would also be desirable to achieve a light guide apparatus comprising a light guide with a plurality of diffraction gratings thereon, which could simplify the light sensor at the end of the light guide.

To better address one or more of these concerns, in a first aspect of the invention there is provided a light guide apparatus, comprising: a light guide, comprising a plurality of diffraction gratings on a first surface of the light guide, wherein each diffraction grating has a pre-set pitch and is configured to diffract a portion of the light emitted from a corresponding light source to one side of the light guide.

As the plurality of diffraction gratings are located on the first surface of the light guide facing the light sources, the light guide apparatus according to the first aspect of the invention is more robust to damage and fingerprints.

An embodiment of the light guide apparatus according to the invention further comprises a reflection layer, covering a second surface opposite to the first surface of the light guide, and having a refractive index lower than the refractive index of the light guide so as to make the diffracted light beams propagate within the light guide by means of total internal reflection.

Preferably, there is provided a cover layer which is adhered to the light guide by the reflection layer according to an embodiment of the light guide apparatus. As the cover layer covers the light guide, it protects the light guide from scratches and fingerprints which will disturb the propagation of the diffracted light within the light guide 1.

Another embodiment of the light guide apparatus according to the invention further comprises a light sensor coupled to one side of the light guide, wherein the light sensor is used to sense intensities and/or colors of the diffracted light beams.

Preferably, there is provided a mirror which is coupled to another side of the light guide, wherein the mirror is used to reflect a part of the diffracted light beams to where the light sensor is coupled.

### BRIEF DESCRIPTION OF THE DRAWINGS

Other features, purposes and advantages of the present invention will become more apparent from the following detailed description of non-limiting exemplary embodiments taken in conjunction with the accompanying drawings.

FIG. 1 is a schematic view of an illumination system according to the previous Philips patent application publication, international publication number: WO 2007/015195 A1;

FIG. 2 illustrates a light guide apparatus according to an embodiment of the invention;

FIG. 3 illustrates the light guide apparatus of FIG. 2 with a reflection layer and a cover layer adhering to the reflection layer;

FIG. 4 illustrates the light guide apparatus of FIG. 3 with a light sensor on the second side of the light guide;

FIG. 5 illustrates the light guide apparatus of FIG. 4 with a mirror on the first side of the light guide;

FIG. 6 illustrates a light guide apparatus having a light guide with three diffraction gratings having respective pitches according to an embodiment of the invention;

FIG. 7 illustrates a light guide apparatus having a light guide with three diffraction gratings having the same pitches according to another embodiment of the invention;

FIG. 8 illustrates the light guide apparatus of FIG. 7 with a reflector and a lens.

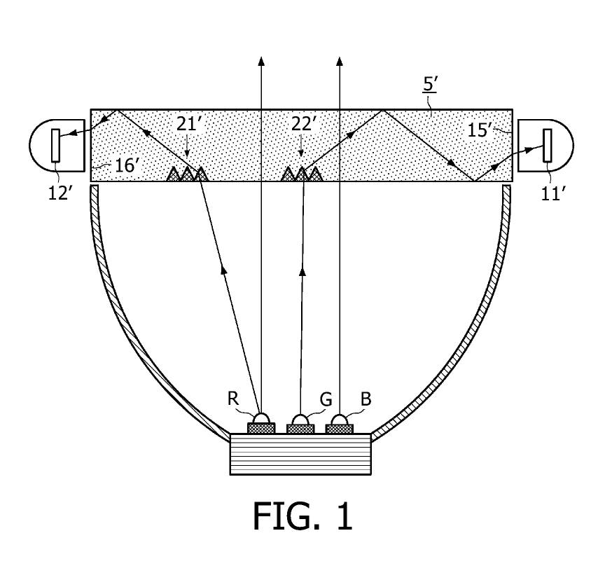

In the Figures, identical or similar reference signs indicate identical or similar step features or devices (modules).

### DETAILED DESCRIPTION OF EMBODIMENTS

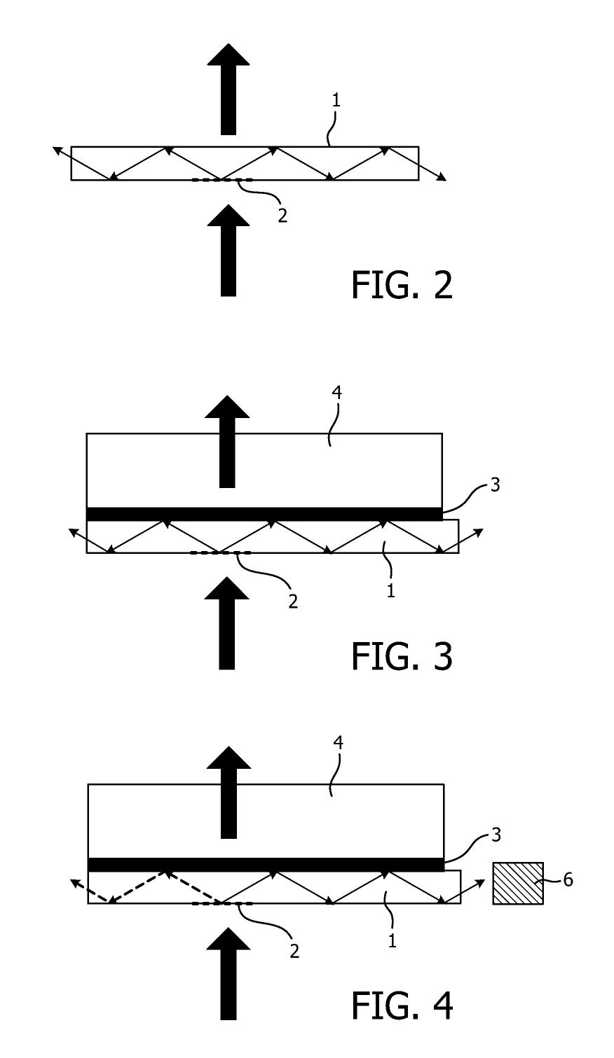

FIG. 2 illustrates a light guide apparatus according to an embodiment of the invention. The light guide apparatus shown in FIG. 2 comprises a light guide 1 and the light guide 1 comprises a diffraction grating 2.

A vertical arrow under the diffraction grating 2 indicates a light source. The light source can be composed of, for example, one or more LEDs.

The light guide 1 is made from a light-transmissive material, for example, polymethyl methacrylate (PMMA), polycarbonate (PC), Polystyrene (PS). The cross section of the light guide 1 can be rectangular or circular.

It should be noted that in FIG. 2, a diffraction grating 2 on the light guide 1 is just an example to explain the principle of a portion of light diffracted by the diffraction grating 2 and propagating within the light guide 1; and the person skilled in the art should understand that in practical usage the light guide 1 can comprise more than one diffraction grating.

Referring to FIG. 2, the diffraction grating 2 is located on the first surface of the light guide 1 which faces the light source. When the light source is supplied with power, a portion of the light emitted from the light source is diffracted by the diffraction grating 2. Then, the diffracted light indicated with a solid-line arrow is guided, for instance, by means of total internal reflection, towards two sides of the light guide 1.

The pitch of the diffraction grating 2, which determines the diffraction angle of the diffracted light, is preset, so that the diffracted light can propagate within the light guide 1 by means of total internal reflection.

The area of the diffraction grating 2 is also preset, so that a predetermined percentage of light emitted from the light source is diffracted and guided to one side of the light guide 1. Preferably, only minute amounts of the light emitted from the light source are diffracted by the diffraction grating 2. The diffracted light is preferably less than 5% of the total amount of light emitted from the light source, so that there is enough light traveling through the light guide 1 to provide illumination.

FIG. 3 illustrates the light guide apparatus of FIG. 2 with a reflection layer and a cover layer adhering to the reflection layer. The light guide apparatus shown in FIG. 3 further comprises a reflection layer 3 and a cover layer 4. The reflection layer 3 covers a second surface opposite to the first surface of the light guide 1 and the cover layer 4 covers the reflection layer 3.

If the diffracted light is guided towards two sides of the light guide 1 by means of total internal reflection, then in order to better realize the total internal reflection of the diffracted light, a reflection layer 3 having a refractive index lower than the refractive index of the light guide 1 is preferably provided on the second surface opposite to the first surface of the light guide 1.

A person of ordinary skill in the art should understand that in order to make the diffracted light propagate within the light guide 1 by means of total internal reflection, the refractive index of the reflection layer 3 must be lower than that of the light guide 1. The lower the refractive index of the reflection layer 3, the easier the diffracted light propagates within the light guide 1 by means of total internal reflection. For example, if the refractive index of the reflection layer 3 is 1.4 and the refractive index of the light guide 1 is 1.5, then total internal reflection will take place for diffracted angles larger than arcsin(1.4/1.5)=69°.

During the usage of aforesaid light guide apparatus, scratches and fingerprints on the light guide 1 are possible. As the scratches and the fingerprints on the light guide 1 will disturb the propagation of the diffracted light within the light guide 1, a cover layer 4 is preferably provided on the reflection layer 3. Usually, the cover layer 4 is made from a transparent material, for example polymer or glass such as PMMA, PC or PS.

In order to fix the cover layer 4 onto the light guide 1, the reflection layer 3 is preferably made from an adhesive material with a low refractive index which can adhere the cover layer 4 to the light guide 1.

FIG. 4 illustrates the light guide apparatus of FIG. 3 with a light sensor on a second side of the light guide. The light guide apparatus shown in FIG. 4 further comprises a light sensor 6 coupled to the second side of the light guide 1.

As shown in FIG. 4, the diffracted light is guided to the two sides of the light guide 1. A first part of the diffracted light indicated with a dashed arrow is guided to the first side of the light guide 1 and a second part of the diffracted light indicated with a solid-line arrow is guided to the second side of the light guide 1. The light sensor 6 is provided on the second side of the light guide 1 to sense the intensity of the diffracted light.

When the light sensor 6 receives the second part of the diffracted light, it converts the received light signal into an electrical signal through which the intensity of the diffracted light is acquired.

In another embodiment, the electrical signal can be sent to a controller (not shown in FIG. 4) for controlling the luminous flux of the light source so as to guarantee the same illumination intensity of the light source during a long time.

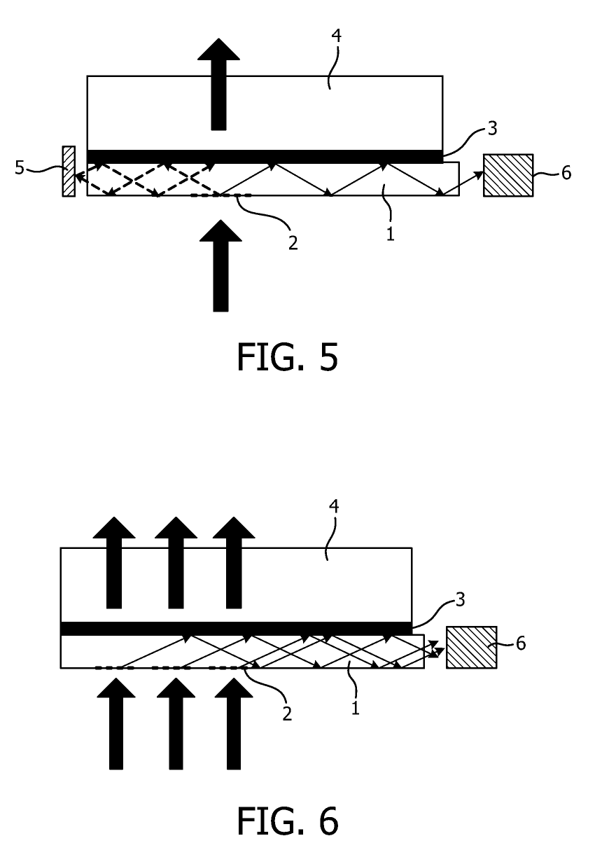

FIG. 5 illustrates the light guide apparatus of FIG. 4 with a mirror on the first side of the light guide. The light guide apparatus shown in FIG. 5 further comprises a mirror 5 coupled to the first side of the light guide 1.

It can be seen in FIG. 4 that only the second part of the diffracted light indicated with a solid-line arrow is guided to the second side of the light guide 1 to which the light sensor 6 is coupled, while the first part of the diffracted light indicated with a dashed arrow is guided to the first side of the light guide 1 and then lost; therefore the total amount of the diffracted light received by the light sensor 6 is relatively reduced, which can reduce the detection sensitivity of the light sensor 6.

In order to supply the light sensor 6 with more light input, a mirror 5 is preferably provided on the first side of the light guide 1. It can be seen in FIG. 5 that the first part of the diffracted light indicated with a dashed arrow is guided to the first side of the light guide 1 to which the mirror 5 is coupled and then reflected by the mirror 5 to the second side of the light guide 1 to which the light sensor 6 is coupled. With the mirror 5 placed on the first side of the light guide 1, most of the light diffracted by the diffraction grating 2 is received by the light sensor 6 except for the minute amount of diffracted light which is lost during the propagation within the light guide 1.

How a portion of the light emitted from the light source is diffracted by the diffraction grating 2 on the light guide 1 and sensed by the light sensor 6 coupled to the second side of the light guide 1 has been described in detail hereinabove, and hereinafter a light guide apparatus with three diffraction gratings on the light guide will be taken as an example to explain how three diffracted light beams respectively diffracted by three diffraction gratings propagate within the light guide and how a light sensor which is coupled to one side of the light guide senses colors and intensities of the three diffracted light beams.

People skilled in the art should understand that the number of diffraction gratings on the light guide is not limited to three.

FIG. 6 illustrates a light guide apparatus having a light guide with three diffraction gratings having their respective pitches according to an embodiment of the invention. Compared with FIG. 4, the light guide apparatus shown in FIG. 6 comprises three diffraction gratings 2 placed on the light guide 1.

As shown in FIG. 6, three vertical arrows under three diffraction gratings 2 respectively indicate three light sources. The light emitted by each light source has a different wavelength. Assuming that the light source on the left side is a red one, the light source in the middle is a green one and the light source on the right side is a blue one. Each light source can be composed of one or more LEDs with the same colors. For instance, the light source on the left side can be composed of one or more red LEDs, the light source in the middle can be composed of one or more green LEDs and the light source on the right side can be composed of one or more blue LEDs.

It should be noted that for the purpose of simplifying FIG. 6, only the second part of the diffracted light beams from each light source indicated with solid-line arrows are shown in FIG. 6, while the first part of the diffracted light beams from each light source is not shown in FIG. 6. However, with reference to FIG. 5, people skilled in the art can understand that if a mirror is coupled to the first side of the light guide 1 in FIG. 6, the first part of the diffracted light beams from each light source will be reflected by the mirror and then guided to the second side of the light guide 1, and in the absence of such a mirror, the first part of the diffracted light beams from each light source will be guided to the first side of the light guide 1 and then lost.

The three diffraction gratings 2 shown in FIG. 6 have their respective pitches. The pitch of each diffraction grating 2 is determined based on the refractive index of the reflection layer 3, the refractive index of the light guide 1 and the wavelength of the light emitted from each light source.

More specifically, the pitch of each diffraction grating 2 is determined based on the following equation (a):

$$Λ = \frac{m λ}{{n}_{d} sin ( {θ}_{d} )} \qquad ( a )$$

Wherein, Λ is the pitch of each diffraction grating 2, n_{d} is the refractive index of the light guide 1, m is the diffraction order, λ is the wavelength of the light emitted from each light source, θ_{d} is the diffracted angle of the light emitted from each light source, corresponding to each diffraction grating 2.

As the diffracted light beams from each light source are guided toward two sides of the light guide 1 by means of total internal reflection, θ_{d} should be chosen larger than arcsin(nᵣ/n_{d}), wherein nᵣ is the refractive index of the reflection layer 3 and n_{d} is the refractive index of the light guide 1. The diffracted angle is preferably chosen close to 90°.

It can be seen from the above equation (a): as the wavelength λ of the light emitted from each light resource is different, in order to make three light beams diffracted by respectively three diffraction gratings 2 have the same diffracted angles θ_{d}, the pitch Λ of each diffraction grating 2 should be different.

The diffraction grating 2 corresponding to the red light source has the largest pitch among the three diffraction gratings 2 due to the light emitted from the red light source having the longest wavelength among the three light sources, and the diffraction grating 2 corresponding to the blue light source has the smallest pitch among the three diffraction gratings 2 due to the light emitted from the blue light source having the shortest wavelength. For instance, if the light guide 1 is made from PMMA, then, for the red light source, green light source and blue light source, the pitch of 425 nm, 375 nm and 325 nm is favorable to achieve large diffraction angles, and if the light guide 1 is made from PC, then, for the red light source, green light source and blue light source, the pitch of 400 nm, 350 nm and 325 nm is favorable to achieve large diffraction angles.

In order to sense colors and intensities of the three diffracted light beams, a light sensor 6 and a color filter are provided on the second side of the light guide 1.

As the three diffracted light beams with the same diffracted angles are mixed when propagating within the light guide 1, a color filter is added to filter the three diffracted light beams and then the light sensor 6 senses the intensities of said filtered three diffracted light beams. As the three light sources are red, green and blue, the color filter in the light sensor 6 comprises a red color filter for filtering the diffracted light from the red light source, a green color filter for filtering the diffracted light from the green light source and a blue color filter for filtering the diffracted light from the blue light source.

When the color filter receives the mixed three diffracted light beams, the red color filter filters the diffracted light from the red light source, the green color filter filters the diffracted light from the green light source, the blue color filter filters the diffracted light from the blue light source, and then the light sensor 6 respectively senses the intensities of the filtered three diffracted lights.

A person skilled in the art should understand that the color filter can be integrated in the light sensor 6, or arranged as a separate means in front of the light sensor 6.

In order to enhance the detection accuracy of the light sensor 6, it is favorable to make the three light beams diffracted by respectively three diffraction gratings 2 have the same diffracted angle, so that the three diffracted light beams will be guided, at the same angle, to the second side of the light guide 1 to which the light sensor 6 is coupled and impinge on the light sensor 6 more intensively.

However, people skilled in the art should understand that, even if the three diffracted light beams are guided, at different angles, to the second side of the light guide 1 to which the light sensor 6 is coupled, the light sensor 6 is able to sense colors and intensities of the three diffracted light beams.

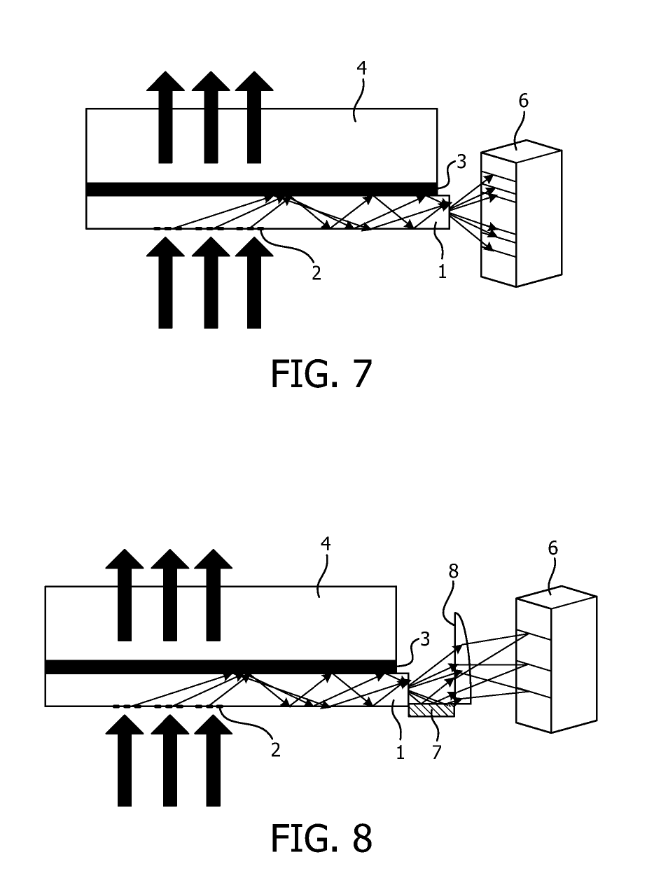

FIG. 7 illustrates a light guide apparatus having a light guide with three diffraction gratings having the same pitches according to another embodiment of the invention. Compared with FIG. 6, three diffraction gratings 2 shown in FIG. 7 have the same pitches.

As shown in FIG. 7, three vertical arrows under three diffraction gratings 2 respectively indicate three light sources. Assuming that the light source on the left side is a red one, the light source in the middle is a green one and the light source on the right side is a blue one.

It should be noted that even though three diffraction gratings 2 with the same pitches are shown in FIG. 7, the three diffraction gratings 2 can be replaced by one diffraction grating.

As the three diffraction gratings 2 shown in FIG. 7 have the same pitches, the diffracted angles of the three diffracted lights respectively diffracted by the three diffraction gratings 2 are different. It can be seen from equation (a) that the diffracted light from the red light source has smallest diffracted angle due to the light emitted from the red light source has longest wavelength, and the diffracted light from the blue light source has largest diffracted angle due to the light emitted from the blue light source has shortest wavelength.

In order to make three diffracted light beams from respectively three light sources propagate within the light guide 1 by means of total internal reflection, the pitches of three diffraction gratings 2 must be carefully determined based on the refractive index of the reflection layer 3 and the refractive index of the light guide 1. For example, in the case that the refractive index of the reflection layer 3 is 1.0, the pitches of three diffraction gratings 2 are 450 nm if the light guide 1 is made from PMMA, and the pitches of three diffraction gratings 2 are 425 nm if the light guide is made from PC.

In order to sense intensities of the three diffracted light beams, a light sensor 6 is provided on the second side of the light guide 1. The light sensor 6 comprises three intensity sensors for sensing intensities of respectively the three diffracted light beams.

As the pitches of the three diffraction gratings 2 are the same, the three light beams diffracted by respectively the three diffraction gratings 2 are guided, at different angles, to the second side of the light guide 1 to which the light sensor 6 is coupled and impinge on the light sensor 6 at different angles. The angle at which each of the three diffracted light beams impinges on the light sensor 6 equals the diffracted angle of each of the three diffracted light beams. The three intensity sensors are placed just where the three diffracted light beams impinge on the light sensor 6 and then sense the intensities of the three diffracted light beams.

As the three diffracted light beams are separated when they impinge on the light sensor 6, there is no need for an additional color filter in the light sensor 6.

In a preferred embodiment as shown in FIG. 8, a reflector 7 and a lens 8 are provided between the light guide 1 and the light sensor 6. The reflector 7 is configured to reflect the downward diffracted light beams in an upward direction and the lens 8 is configured to focus the diffracted light beams onto the three intensity sensors in the light sensor 6.

Although embodiments of the present invention have been described above, it will be understood by those skilled in the art that various modifications can be made without departing from the scope and spirit of the scope of the attached claims.

1. A light guide apparatus, comprising:
a light guide (1), comprising a plurality of diffraction gratings (2) on a first surface of the light guide (1), wherein each diffraction grating (2) has a pre-set pitch and is configured to diffract a portion of the light emitted from a-corresponding light source to one side of the light guide (1).

2. A light guide apparatus as claimed in claim 1, further comprising a reflection layer (3), covering a second surface opposite to the first surface of the light guide (1), and having a refractive index lower than the refractive index of the light guide (1) so as to make the diffracted light beams propagate within the light guide (1) by means of total internal reflection.

3. A light guide apparatus as claimed in claim 2, further comprising a cover layer (4) adhering to the light guide (1) by the reflection layer (3).

4. A light guide apparatus as claimed in claim 2, wherein each diffraction grating (2) has a pitch based on the refractive indexes of the reflection layer (3) and the light guide (1), and the wavelength of the light emitted from a light source corresponding to each diffraction grating (2).

5. A light guide-apparatus as claimed in claim 4, wherein the pitch is determined based on the following equation:
$$Λ = \frac{m λ}{{n}_{d} sin ( {θ}_{d} )}$$
wherein Λ is the pitch of each diffraction grating (2), n_{d} is the refractive index of the light guide (1), m is the diffraction order, λ is the wavelength of the light emitted from a light source corresponding to each diffraction grating (2), θ_{d} is the diffracted angle of the light emitted from a light source corresponding to each diffraction grating (2), wherein θ_{d} is chosen larger than arcsin(nᵣ/n_{d}), nᵣ is the refractive index of the reflection layer (3).

6. A light guide apparatus as claimed in claim 4, wherein different diffraction gratings (2) corresponding to different light sources generating light beams of different wavelengths are configured with different pitches so as to make the diffracted light beams of different wavelengths propagate at the same angle within the light guide (1).

7. A light guide apparatus as claimed in claim 2, wherein each diffraction grating (2) is configured with the same pitch based on the refractive indexes of the reflection layer (3) and the light guide (1), so as to make the diffracted light beams of different wavelengths propagate at different angles within the light guide (1).

8. A light guide apparatus as claimed in claim 7, wherein the pitch is 450 nm for the light guide (1) made of PMMA or 425 nm for the light guide (1) made of Polycarbonate.

9. A light guide apparatus as claimed in claim 1, further comprising a mirror (5) coupled to one side of the light guide (1), wherein the mirror (5) is used to reflect a part of the diffracted light beams to another side of the light guide (1).

10. A light guide apparatus as claimed in claim 1, further comprising a light sensor (6) coupled to one side of the light guide (1), wherein the light sensor (6) is used to sense intensities and/or colors of the diffracted light beams.

11. A light guide apparatus as claimed in claim 10, wherein different diffraction gratings (2) corresponding to different light sources generating light beams of different wavelengths are configured with different pitches so as to make the diffracted light beams of different wavelengths propagate at the same angle within the light guide (1), wherein the light sensor (6) is used to sense colors and intensities of the diffracted light beams of different wavelengths.

12. A light guide apparatus as claimed in claim 10, wherein each diffraction grating (2) is configured with the same pitch so as to make the diffracted light beams of different wavelengths propagate at different angles within the light guide (1) and impinge on the light sensor (6) at different angles, wherein the light sensor (6) comprises a plurality of intensity sensors placed where the diffracted light beams of different wavelengths impinge on the light sensor (6) to respectively sense intensities of the diffracted light beams of different wavelengths.

13. A light guide apparatus as claimed in claim 12, further comprising a reflector (7) and a lens (8) placed between the light guide (1) and the plurality of intensity sensors, wherein, the reflector (7) and the lens (8) are configured to focus the diffracted light beams of different wavelengths onto the plurality of intensity sensors.

14. A light guide apparatus as claimed in claim 1, wherein the area of each diffraction grating (2) is configured to ensure that a pre-determined percentage of light emitted from a corresponding light source is diffracted to one side of the light guide (1).
